(19) United States
(12) Patent Application Publication
(10) Pub. No.: US 2025/0323456 A1
(43) Pub. Date: Oct. 16, 2025

(54) Connector

(71) Applicant: Tyco Electronics (Shanghai) Co., Ltd., Shanghai (CN)

(72) Inventors: Qi Feng, Shanghai (CN); Ziwei (Vivi) Li, Shanghai (CN); Yuchen Yang, Shanghai (CN)

(73) Assignee: Tyco Electronics (Shanghai) Co., Ltd., Shanghai (CN)

(21) Appl. No.: 19/176,387

(22) Filed: Apr. 11, 2025

(30) Foreign Application Priority Data
Apr. 12, 2024 (CN) 202420766112.7

(51) Int. Cl. H01R 13/621; H01R 13/02; H01R 13/52; H01R 13/639; H01R 13/6581; H01R 13/66

(52) U.S. Cl. CPC H01R 13/6215; H01R 13/02; H01R 13/5202; H01R 13/639; H01R 13/6581; H01R 13/6683

(57) ABSTRACT

A connector includes an outer shielding shell, an inner insulation housing, an electric transmission component, a conductive terminal, an insulation retaining body, and a fastening assembly. The outer shielding shell has a front port and a rear port opposite each other in a longitudinal direction of the outer shielding shell, and a top wall and a bottom opening opposite each other in a height direction of the outer shielding shell. An installation port is formed in the top wall. The inner insulation housing is inserted into the outer shielding shell from the rear port and has an insertion cavity in communication with the rear port, the bottom opening, and the installation port. The electric transmission component is inserted into the insertion cavity and led out from the rear port. The conductive terminal welded to a front end of the electric transmission component electrically contacts a mating terminal of a mating connector. The insulation retaining body installed in the bottom opening retains and positions the conductive terminal. The fastening assembly entering the inner insulation housing through the installation port fastens the conductive terminal to the mating terminal.

### CROSS-REFERENCE TO RELATED APPLICATION

This application claims the benefit of the filing date under 35 U.S.C. § 119(a)-(d) of Chinese Patent Application No. CN202420766112.7 filed on Apr. 12, 2024.

### FIELD OF THE INVENTION

The present invention relates to a connector.

### BACKGROUND OF THE INVENTION

In the new energy vehicle, the high-voltage bolt connector is a very important component. The high-voltage bolt is generally used for the electrical connection between the charging seat and the battery. The high-voltage bolt transmits electrical energy to the charging battery to charge the charging battery in the battery pack. In the prior art, the connector at the charging seat end has the problems of having a complex structure and a large volume, and it is difficult to simultaneously achieve functions such as waterproof sealing, electromagnetic shielding, high-voltage interlocking, and finger protection.

### SUMMARY OF THE INVENTION

A connector includes an outer shielding shell, an inner insulation housing, an electric transmission component, a conductive terminal, an insulation retaining body, and a fastening assembly. The outer shielding shell has a front port and a rear port opposite each other in a longitudinal direction of the outer shielding shell, and a top wall and a bottom opening opposite each other in a height direction of the outer shielding shell. An installation port is formed in the top wall. The inner insulation housing is inserted into the outer shielding shell from the rear port and has an insertion cavity in communication with the rear port, the bottom opening, and the installation port. The electric transmission component is inserted into the insertion cavity and led out from the rear port. The conductive terminal welded to a front end of the electric transmission component electrically contacts a mating terminal of a mating connector. The insulation retaining body installed in the bottom opening retains and positions the conductive terminal. The fastening assembly entering the inner insulation housing through the installation port fastens the conductive terminal to the mating terminal.

### BRIEF DESCRIPTION OF DRAWINGS

The invention will now be described by way of example with reference to the accompanying figures, of which:

FIG. 1 is a perspective view of a connector according to an exemplary embodiment;

FIG. 2 is a longitudinal sectional top view of the connector of FIG. 1;

FIG. 3 is a longitudinal sectional bottom view of the connector of FIG. 1;

FIG. 4 is a perspective view of an outer shielding shell and an inner insulation housing of the connector of FIG. 1;

FIG. 5 is a perspective view of fastening assemblies of the connector of FIG. 1, where one fastening assembly has not yet been pre-installed into the inner insulation housing of FIG. 4;

FIG. 6 is a longitudinal sectional view of the connector of FIG. 1, where the fastening assemblies of FIG. 5 are pre-installed into the inner insulation housing of FIG. 4 and retained within the inner insulation housing;

FIG. 7 is a longitudinal sectional view of the connector of FIG. 1, where a low voltage detection terminal of the connector is shown;

FIG. 8 is a perspective view of one fastening assembly of FIG. 5;

FIG. 9 is a cross-sectional view of one fastening assembly of FIG. 5;

FIG. 10 is an exploded cross-sectional view of one fastening assembly of FIG. 5;

FIG. 11 is a perspective view of two electric transmission components of the connector of FIG. 1;

FIG. 12 is a cross-sectional view of one fastening assembly of FIG. 5, the electric transmission component of FIG. 11, and a conductive terminal of the connector of FIG. 1; and

FIG. 13 is a cross-sectional exploded view of one fastening assembly of FIG. 5, the electric transmission component of FIG. 11, and the conductive terminal of FIG. 12.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

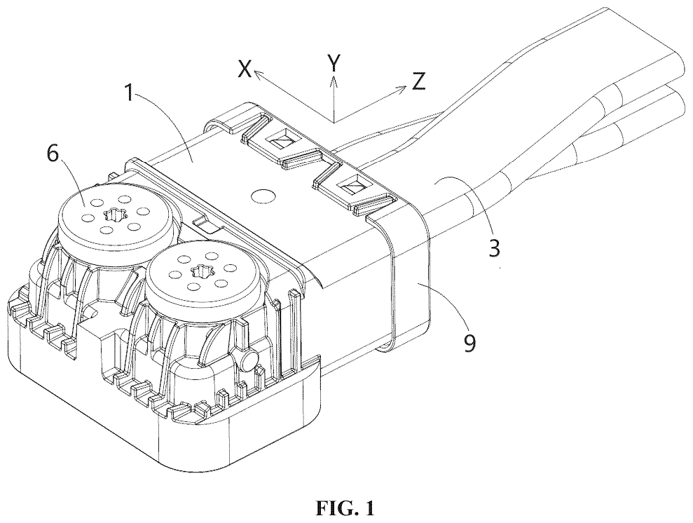

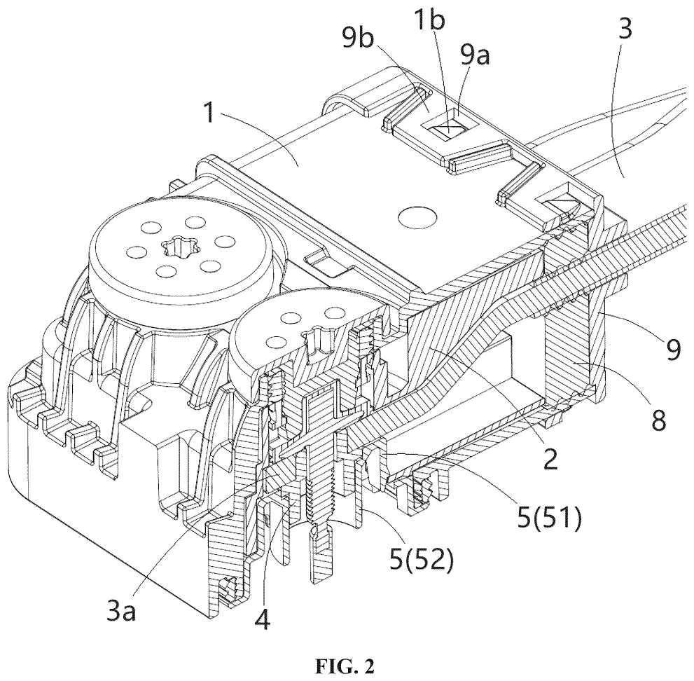

An exemplary embodiment of a connector is now described with reference to FIGS. 1-13. As shown in FIGS. 1-2, the connector comprises an outer shielding shell 1, an inner insulation housing 2, an electric transmission component 3, a conductive terminal 4, an insulation retaining body 5, and a fastening assembly 6.

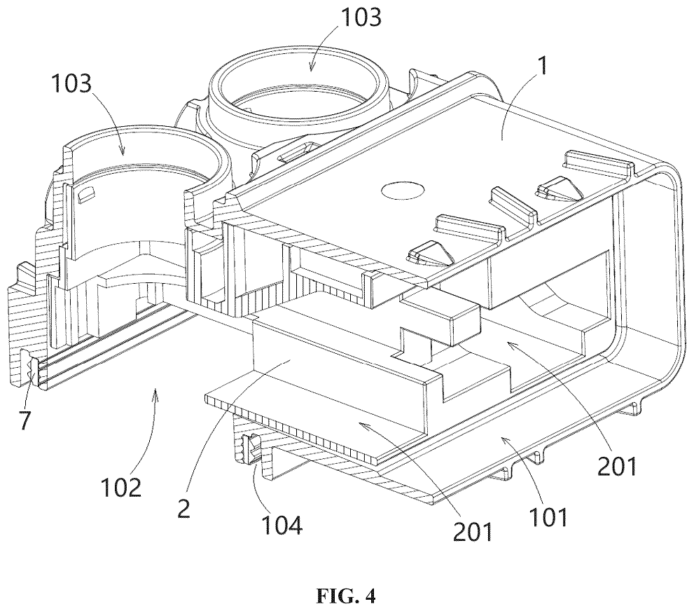

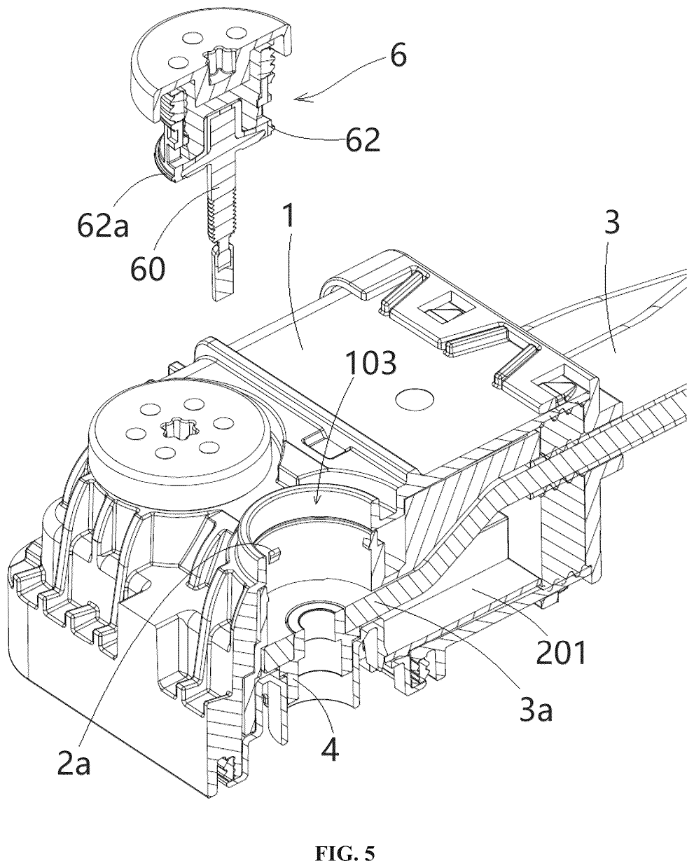

As shown in FIG. 4, the outer shielding shell 1 includes a front end wall and a rear port 101 that are opposite each other in a longitudinal direction Y of the outer shielding shell 1, and a top wall and a bottom opening 102 that are opposite each other in a height direction Z of the outer shielding shell 1. An installation port 103, as shown in FIGS. 4-5, is formed in the top wall of the outer shielding shell 1.

The inner insulation housing 2, as shown in FIGS. 2-4 and 6, is inserted into the outer shielding shell 1 from the rear port 101 of the outer shielding shell 1. As shown in FIG. 4, the inner insulation housing 2 has an insertion cavity 201 in communication with the rear port 101, bottom opening 102, and installation port 103 of the outer shielding shell 1.

As shown in FIGS. 2, 5, and 11-13, the electric transmission component 3 has a front end 3a. The electric transmission component 3 is inserted into the insertion cavity 201 of the inner insulation housing 2 and led out from the rear port 101 of the outer shielding shell 1.

The conductive terminal 4, as shown in FIGS. 2-3, 5, and 12, is soldered or welded to the front end 3a. The conductive terminal 4 electrically contacts a mating terminal of a mating connector.

The insulation retaining body 5, as shown in FIG. 2, is installed in the bottom opening 102 of the outer shielding shell 1 and holds and positions the conductive terminal 4. The fastening assembly 6, as shown in FIGS. 1 and 5, enters the inner insulation housing 2 through the installation port 103 in the top wall of the outer shielding shell 1, and is used to fasten the conductive terminal 4 to the mating terminal.

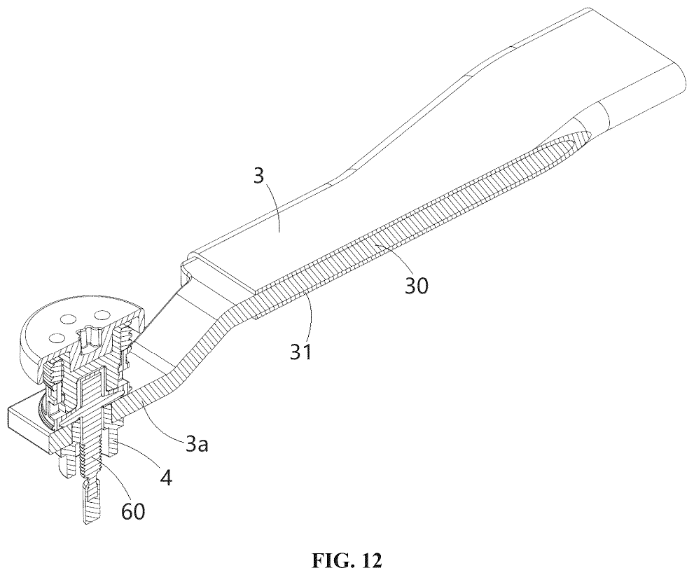

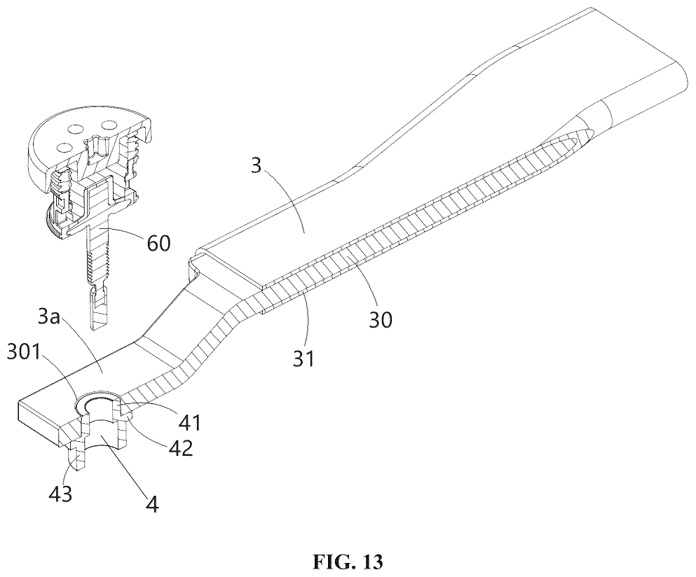

As shown in FIGS. 12-13, the electric transmission component 3 includes a metal bar 30 that is flat and an outer insulation layer 31 wrapped around the metal bar 30. The front end 3a is at a front of the metal bar 30 and exposed from the outer insulation layer 31. The conductive terminal 4 is cylindrical and vertically welded to the front end 3a. In an exemplary embodiment of the present invention, the aforementioned metal bar 30 can be an aluminum bar, which can reduce manufacturing costs.

As shown in FIG. 13, the conductive terminal 4 includes a first cylindrical part 41, a second cylindrical part 43, and a flange part 42. The first cylindrical part 41 is located at one end of the conductive terminal 4. The second cylindrical part 43 is located at the other end of the conductive terminal 4. The flange part 42 is located between the first cylindrical part 41 and the second cylindrical part 43. A socket 301, as shown in FIG. 13, is formed in the front end 3a. The first cylindrical part 41 is inserted and welded into the socket 301, the flange part 42 is welded to the surface of the front end 3a, and the end face of the second cylindrical part 43 is used for axial electrical contact with the end face of the mating terminal.

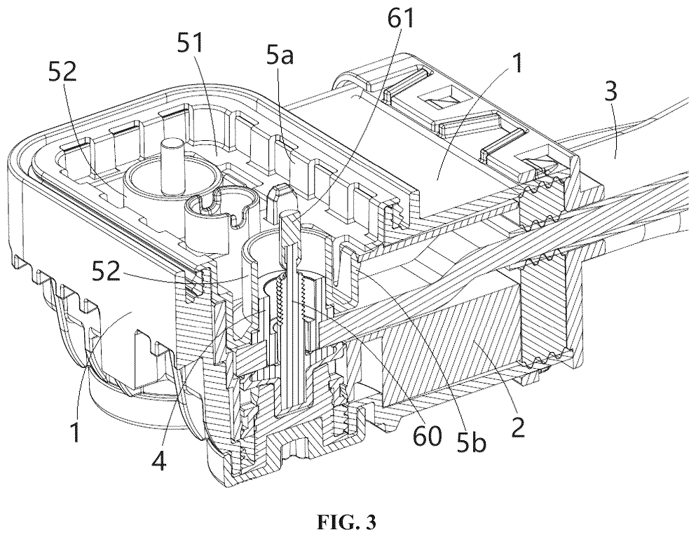

As shown in FIG. 2, the insulation retaining body 5 includes an insulation bracket 51 and an insulation sleeve 52. The insulation bracket 51, as shown in FIGS. 2-3 and 7, is fixed to the outer shielding shell 1 and the inner insulation housing 2. The insulation sleeve 52, as shown in FIGS. 2-3, is formed on the insulation bracket 51. The second cylindrical part 43 of the conductive terminal 4 is inserted and held in the insulation sleeve 52 of the insulation retaining body 5.

As shown in FIG. 3, a first elastic buckle 5a and a second elastic buckle 5b are formed on the insulation bracket 51. The first elastic buckle 5a and the second elastic buckle 5b are respectively engaged to the outer shielding shell 1 and the inner insulation housing 2 to fix the insulation retaining body 5 to the outer shielding shell 1 and the inner insulation housing 2.

As shown in FIGS. 3 and 8-10, the fastening assembly 6 includes a bolt 60 and an insulation end cap 61. The bolt 60 passes through the conductive terminal 4 and is used for threaded connection with the mating terminal or a nut inside the mating connector (i.e., fastens the mating terminal or a nut inside the mating terminal to the conductive terminal 4). The fastening assembly 6 secures the conductive terminal 4 to the mating terminal. The insulation end cap 61 is fitted or formed on the end of the bolt 60 to prevent human fingers from touching the end of the bolt 60. In other words, the insulation end cap 61 prevents the end of the bolt 60 from being touched. The insulation sleeve 52 extends beyond the end face of the second cylindrical part 43 of the conductive terminal 4, and the insulation end cap 61 is located in the insulation sleeve 52. A gap between the insulation end cap 61 and the insulation sleeve 52 is smaller than that of a human finger to prevent finger insertion. In other words, the gap is sized to prevent finger insertion therein. In an exemplary embodiment of the present invention, the insulation end cap 61 may be an injection molded part directly formed on the end of the bolt 60 through an embedded injection molding process.

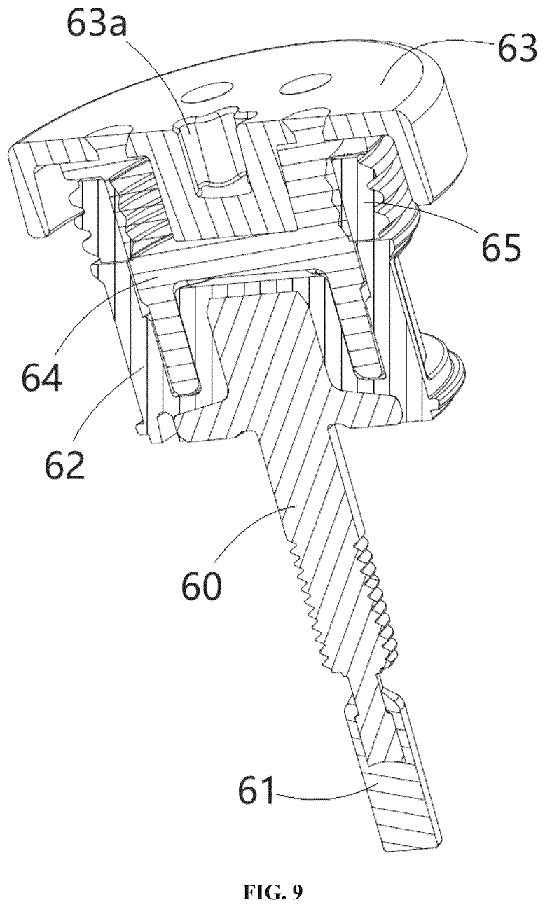

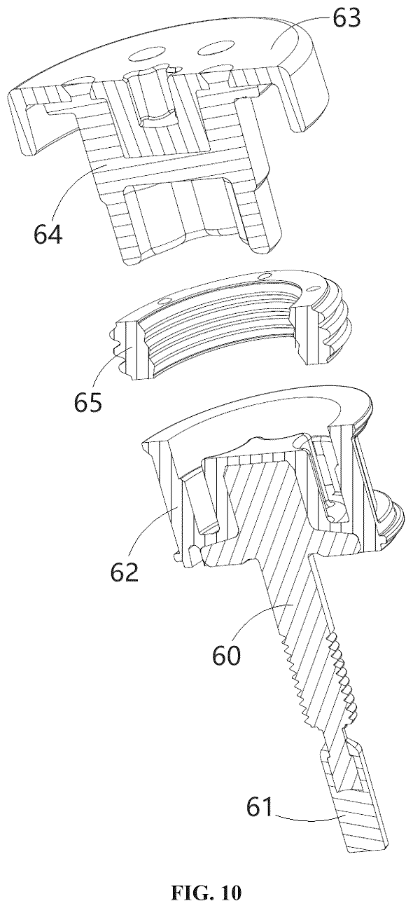

As shown in FIGS. 9-10, the fastening assembly 6 further comprises a first insulator 62, a shielding cap 63, and a second insulator 64. The first insulator 62 is formed on the head of the bolt 60. The shielding cap 63 is used for installation onto the installation port 103 of the outer shielding shell 1. The second insulator 64 is formed on the inner side of the shielding cap 63. The first insulator 62 and the second insulator 64 are engaged together to connect the shielding cap 63 and the bolt 60, and to electrically isolate the shielding cap 63 from the bolt 60. In an exemplary embodiment of the present invention, the first insulator 62 may be an injection molded part directly formed on the head of the bolt 60 through an insert injection molding process. The second insulator 64 can be an injection molded part directly formed on the inner side of the shielding cap 63 through an embedded injection molding process. The shielding cap 63 is suitable for covering the installation port 103 and for making electrical contact with the outer peripheral surface of the peripheral wall of the installation port 103 to prevent electromagnetic leakage.

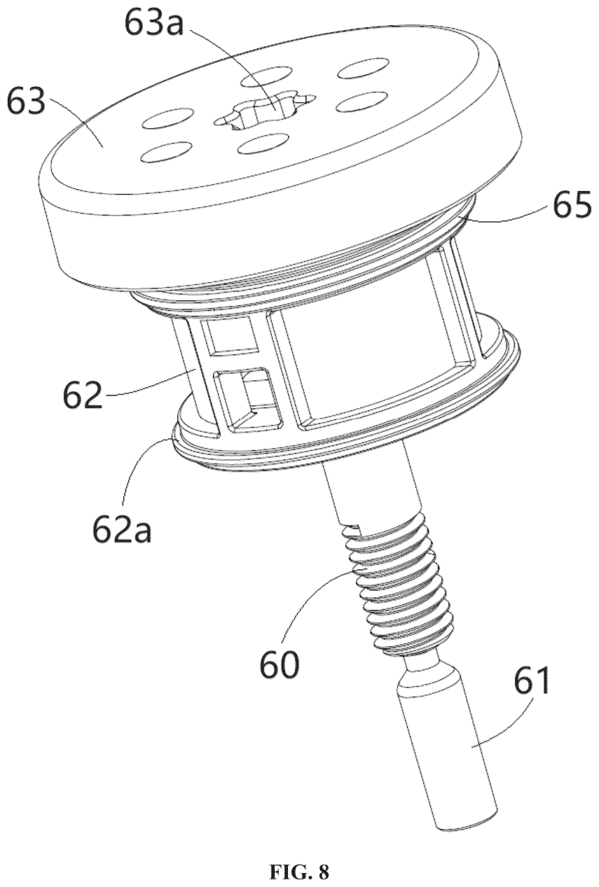

As shown in FIGS. 8-9, a joint part 63a suitable for engagement with an operating tool is formed on the outer side of the shielding cap 63. The operating tool engaged with the joint part 63a can tighten or loosen the bolt 60. In the illustrated embodiment, the joint part 63a is a concave part with a cross section in the shape of a plum blossom.

As shown in FIGS. 9-10, the fastening assembly 6 further comprises a sealing ring 65, which is fitted onto the second insulator 64. The sealing ring 65 is adapted to be radially compressed between the second insulator 64 and the inner peripheral surface of the peripheral wall of the installation port 103 to seal the installation port 103.

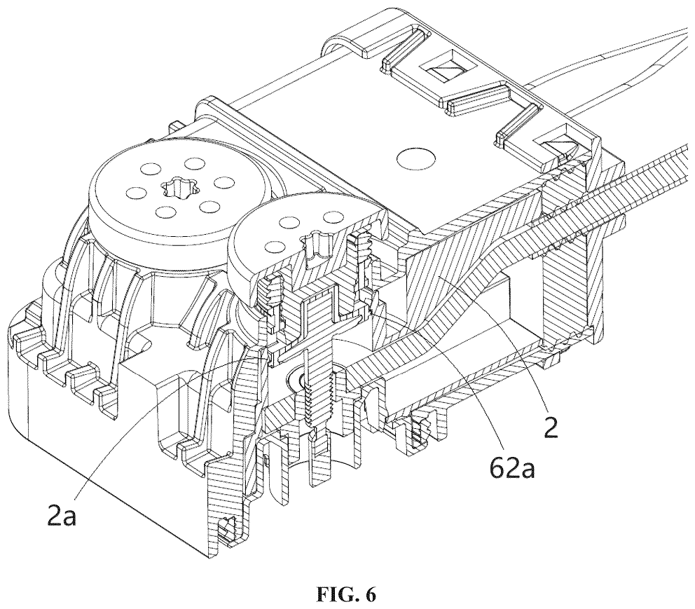

As shown in FIGS. 5 and 9, a limit flange 62a is formed on the first insulator 62. As shown in FIGS. 5 and 6, a limit protrusion 2a is formed in the inner insulation housing 2. The fastening assembly 6 is pre-installed into the inner insulation housing 2. The limit protrusion 2a is used to interfere with the limit flange 62a to prevent the fastening assembly 6 pre-installed in the inner insulation housing 2 from detaching from the inner insulation housing 2.

As shown in FIGS. 1-7 and 11, the connector includes two electric transmission components 3, two conductive terminals 4, and two fastening assemblies 6. The two conductive terminals 4 are respectively welded to the front ends 3a of the two electric transmission components 3. The inner insulation housing 2 has two insertion cavities 201, the insulation retaining body 5 has two insulation sleeves 52, and the outer shielding shell 1 has two installation ports 103. The two electric transmission components 3 are respectively inserted into the two insertion cavities 201, the two conductive terminals 4 are respectively held in two insulation sleeves 52, and the two fastening assemblies 6 enter the inner insulation housing 2 through two installation ports 103.

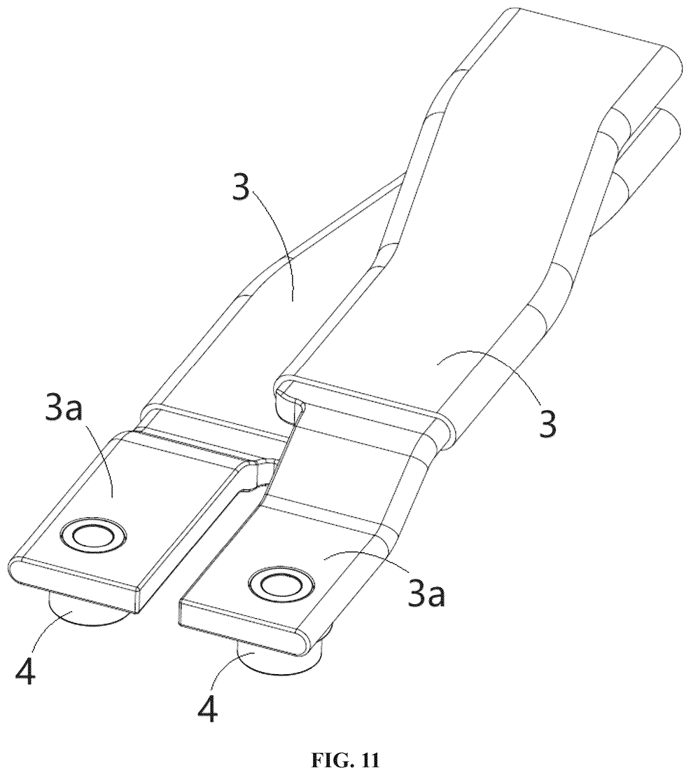

As shown in FIG. 11, the front ends 3a are arranged side by side in the transverse direction X of the outer shielding shell 1 and at the same height in the height direction Z of the outer shielding shell 1. Outlets of the two insertion cavities 201 of the inner insulation housing 2 are spaced apart in the height direction Z and at least partially overlap with each other, so that the two electric transmission components 3 led out from the outlets of the two insertion cavities 201 are spaced apart in the height direction Z and at least partially overlap with each other.

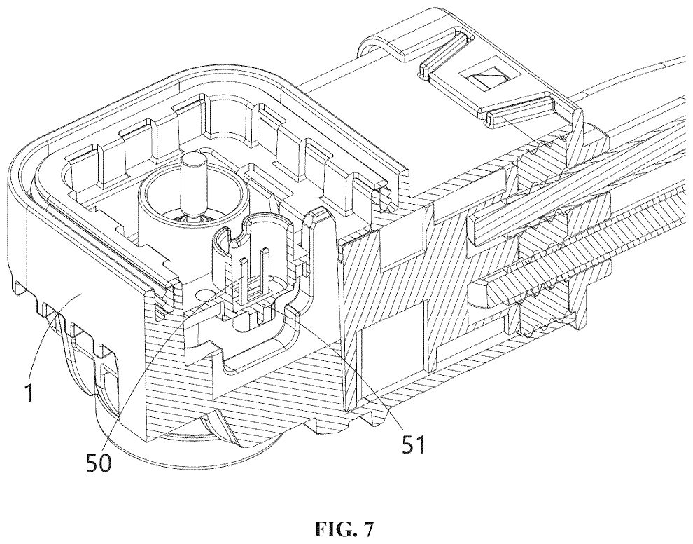

As shown in FIG. 7, the connector further comprises a low-voltage detection terminal 50, which is fixed to the insulation retaining body 5 and located between two insulation sleeves 52 for mating with a mating detection terminal of the mating connector. After the connector is mated with the mating connector, the conductive terminal 4 of the connector is electrically connected to the mating terminal of the mating connector to connect a high-voltage load circuit. After the connector is mated with the mating connector, the low-voltage detection terminal 50 is mated with the mating detection terminal to connect a low-voltage control circuit and control the power supply to supply power to the high-voltage load circuit by the low-voltage control circuit. This can improve the safety of use.

As shown in FIG. 4, a groove 104 that is circular is formed in the bottom wall of the outer shielding shell 1. The groove 104 surrounds the bottom opening 102 of the outer shielding shell 1. When the connector is mated with the mating connector, the peripheral part of the mating shielding shell of the mating connector is inserted into the groove 104 of the outer shielding shell 1 and electrically contacts the outer shielding shell 1.

As shown in FIG. 4, the connector further comprises a sealing ring 7. The sealing ring 7 is installed in the groove 104 of the outer shielding shell 1. When the connector is mated with the mating connector, the sealing ring 7 is radially compressed between the outer shielding shell 1 and the mating shielding shell to achieve sealing between the two.

As shown in FIGS. 2, the connector further comprises a sealing element 8. The sealing element 8 is inserted into the rear port 101 of the outer shielding shell 1 for sealing the rear port 101. The electric transmission component 3 passes through the sealing element 8, and the sealing element 8 is compressed between the outer insulation layer 31 of the electric transmission component 3 and the inner peripheral surface of the rear port 101.

As shown in FIGS. 1-2, the connector further comprises a rear end cover 9. The rear end cover 9 is installed on the rear end of the outer shielding shell 1 and formed with a through-hole that allows the electric transmission component 3 to pass through. The rear end cover 9 is used to fix the electric transmission component 3 to the rear end of the outer shielding shell 1 to prevent the electric transmission component 3 from moving (e.g., shaking).

As shown in FIG. 2, an elastic buckle 9b is formed on the rear end cover 9, and a protrusion 1b is formed on the outer peripheral surface of the rear end of the outer shielding shell 1. The protrusion 1b is engaged with a snap slot 9a of the elastic buckle 9b to fix the rear end cover 9 to the rear end of the outer shielding shell 1.

As shown in FIG. 2, the sealing element 8 has two ends opposite each other in the longitudinal direction Y of the outer shielding shell 1. The two ends of the sealing element 8 are respectively pressed against one of the rear end face of the inner insulation housing 2 and the rear end cover 9. The two ends of the sealing element 8 position the sealing element 8 in the rear port 101 of the outer shielding shell 1.

In the aforementioned exemplary embodiments according to the present invention, the structure of the connector is simple, the volume of the connector is small, and the miniaturization of the connector can be achieved. Moreover, the connector can simultaneously achieve functions such as waterproof sealing, electromagnetic shielding, high-voltage interlocking, and finger protection (i.e., protecting human fingers).

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A connector, comprising:
an outer shielding shell having a front port and a rear port opposite each other in a longitudinal direction of the outer shielding shell, and a top wall and a bottom opening opposite each other in a height direction of the outer shielding shell, an installation port is formed in the top wall;
an inner insulation housing inserted into the outer shielding shell from the rear port and having an insertion cavity in communication with the rear port, the bottom opening, and the installation port;
an electric transmission component inserted into the insertion cavity and led out from the rear port;
a conductive terminal welded to a front end of the electric transmission component electrically contacts a mating terminal of a mating connector;
an insulation retaining body installed in the bottom opening retains and positions the conductive terminal; and
a fastening assembly entering the inner insulation housing through the installation port fastens the conductive terminal to the mating terminal.

2. The connector of claim 1, wherein the electric transmission component includes a metal bar that is flat and an outer insulation layer wrapped on the metal bar, the front end of the electric transmission component is at a front of the metal bar and is exposed from the outer insulation layer, the conductive terminal is cylindrical and vertically welded to the front end of the electric transmission component.

3. The connector of claim 1, wherein the conductive terminal includes a first cylindrical part, a second cylindrical part, and a flange part, the first cylindrical part is located at one end of the conductive terminal, the second cylindrical part is located at an other end of the conductive terminal, and the flange part is located between the first cylindrical part and the second cylindrical part, a socket is formed in the front end of electric transmission component, the first cylindrical part is inserted and welded into the socket, the flange part is welded to a surface of the front end of the electric transmission component, and an end face of the second cylindrical part axially electrically contacts an end face of the mating terminal.

4. The connector of claim 3, wherein the insulation retaining body includes an insulation bracket, and an insulation sleeve, the insulation bracket is fixed to the outer shielding shell and the inner insulation housing, the insulation sleeve is formed on the insulation bracket, the second cylindrical part is inserted and held in the insulation sleeve.

5. The connector of claim 4, wherein a first elastic buckle and a second elastic buckle are formed on the insulation bracket, the first elastic buckle and the second elastic buckle are engaged to one of the outer shielding shell and the inner insulation housing, the first elastic buckle and the second elastic buckle fix the insulation retaining body to the outer shielding shell and the inner insulation housing.

6. The connector of claim 4, wherein the fastening assembly includes a bolt and an insulation end cap, the bolt passes through the conductive terminal and fastens the mating terminal or a nut inside the mating connector to the conductive terminal, the insulation end cap is fitted or formed on an end of the bolt to prevent the end of the bolt from being touched, the insulation sleeve extends beyond the end face of the second cylindrical part, and the insulation end cap is located in the insulation sleeve, a gap between the insulation end cap and the insulation sleeve is sized to prevent finger insertion therein.

7. The connector of claim 6, wherein the fastening assembly includes a first insulator, a shielding cap, and a second insulator, the first insulator is formed on a head of the bolt, the shielding cap is installed onto the installation port, and the second insulator is formed on an inner side of the shielding cap, the first insulator and the second insulator are engaged together to join the shielding cap and the bolt together and electrically isolate the shielding cap from the bolt, the shielding cap covers the installation port and makes electrical contact with an outer peripheral surface of a peripheral wall of the installation port to prevent electromagnetic leakage.

8. The connector of claim 7, wherein a joint part suitable for engaging with an operating tool is formed on an outer side of the shielding cap, the operating tool engaged with the joint part tightens or loosens the bolt.

9. The connector of claim 7, wherein the fastening assembly includes a sealing ring fitted onto the second insulator, the sealing ring is radially compressed between an inner peripheral surface of the second insulator and the peripheral wall of the installation port to seal the installation port.

10. The connector of claim 7, wherein a limit flange is formed on the first insulator, and a limit protrusion is formed in the inner insulation housing, the fastening assembly is pre-installed into the inner insulation housing, and the limit protrusion interferes with the limit flange to prevent the fastening assembly pre-installed in the inner insulation housing from detaching from the inner insulation housing.

11. The connector of claim 3, wherein the connector comprises two electric transmission components, two conductive terminals, and two fastening assemblies, the two conductive terminals are each welded to one front end of each of the two electric transmission components, the inner insulation housing has two insertion cavities, the insulation retaining body has two insulation sleeves, and the outer shielding shell has two installation ports, the two electric transmission components are each inserted into one of the two insertion cavities, the two conductive terminals are each held in one of the two insulation sleeves, and the two fastening assemblies each enter the inner insulation housing through one of the two installation ports.

12. The connector of claim 11, wherein the front ends of each of the two electric transmission components are arranged side by side in a transverse direction of the outer shielding shell and at the same height in the height direction of the outer shielding shell, outlets of the two insertion cavities are spaced apart in the height direction and at least partially overlap with each other such that the two electric transmission components led out from the outlets are spaced apart in the height direction and at least partially overlap with each other.

13. The connector of claim 11, further comprising a low-voltage detection terminal fixed to the insulation retaining body and located between the two insulation sleeves, the low-voltage detection terminal mates with a mating detection terminal of the mating connector, after the connector is mated with the mating connector, the conductive terminal of the connector is electrically connected to the mating terminal of the mating connector to connect a high-voltage load circuit, and after the connector is mated with the mating connector, the low-voltage detection terminal is mated with the mating detection terminal to connect a low-voltage control circuit and control a power supply to supply power to the high-voltage load circuit by the low-voltage control circuit.

14. The connector of claim 1, wherein a groove formed in a bottom wall of the outer shielding shell surrounds the bottom opening, when the connector is mated with the mating connector, a peripheral part of a mating shielding shell of the mating connector is inserted into the groove and electrically contacts the outer shielding shell.

15. The connector of claim 14, further comprising a sealing ring installed in the groove, when the connector is mated with the mating connector, the sealing ring is radially compressed between the outer shielding shell and the mating shielding shell to achieve sealing between the two.

16. The connector of claim 2, further comprising a sealing element inserted into the rear port for sealing the rear port, the electric transmission component passes through the sealing element, and the sealing element is compressed between the outer insulation layer of the electric transmission component and an inner peripheral surface of the rear port of the outer shielding shell.

17. The connector of claim 16, further comprising a rear end cover installed on a rear end of the outer shielding shell and formed with a through-hole allowing the electric transmission component to pass through, the rear end cover fixes the electric transmission component to the rear end of the outer shielding shell and prevents the electric transmission component from moving.

18. The connector of claim 17, wherein an elastic buckle is formed on the rear end cover, and a protrusion is formed on an outer peripheral surface of the rear end of the outer shielding shell, the protrusion engages with a snap slot of the elastic buckle and fixes the rear end cover to the rear end of the outer shielding shell.

19. The connector of claim 17, wherein the sealing element has two ends opposite each other in the longitudinal direction, and the two ends of the sealing element are pressed against one of a rear end face of the inner insulation housing and the rear end cover, the two ends of the sealing element position the sealing element in the rear port.
